(19) United States
(12) Patent Application Publication
(10) Pub. No.: US 2003/0215263 A1
(43) Pub. Date: Nov. 20, 2003

(54) Spacing device for image processing systems

(75) Inventor: Dean Liu, West Hills, CA (US)

Correspondence Address: ORRICK, HERRINGTON & SUTCLIFFE, LLP, 4 PARK PLAZA, SUITE 1600, IRVINE, CA, 92614-2558, US

(73) Assignee: AETAS TECHNOLOGY INC

(21) Appl. No.: 10/151,715

(22) Filed: May 18, 2002

(51) Int. Cl. G03G 15/00; G03G 15/06

(52) U.S. Cl. 399/159; 399/162; 399/222

(57) ABSTRACT

A spacing device for image processing systems to maintain a development gap between an image-receiving member and a developer roller thereby facilitating efficient development and consistently maintaining high image quality and methods for manufacturing and using the same. The spacing device comprises one or more spacing members that have preselected lengths and that are configured to be coupled with, and extend from, an imaging-receiving module and/or a developer cartridge of an image processing system. When the image processing system is properly assembled, a predetermined development gap is formed between an image-receiving member of the imaging-receiving module and a developer roller of the developer cartridge, and the spacing members are disposed substantially between, and in contact with, the imaging-receiving module and the developer cartridge. The spacing members, being formed from a substantially rigid material, are configured to maintain the predetermined development gap.

### FIELD OF THE INVENTION

The present invention relates generally to electrophotography and, more particularly, to a non-contact image processing system that facilitates efficient development and consistently maintains high image quality of an electrostatic image.

### BACKGROUND OF THE INVENTION

Image processing systems, such as laser printers and photocopiers, are provided with an image-receiving member or photoreceptor, such as a photosensitive drum or belt. At the time of copying or printing, the surface of the image-bearing member is uniformly charged to a predetermined electric potential and polarity. Light is then radiated from a light source onto the uniformly charged image-bearing member to dissipate the charge and create a corresponding latent electrostatic image thereon. For a typical copier, light from a lamp is reflected onto the photosensitive member from a document to be copied. For a typical printer, light from a modulated laser or a linear array of light sources converts digital information into a latent image on the photosensitive member.

Image processing systems also are provided with a developing system that develops the latent electrostatic image by directing toner particles to the latent image on the surface of the image-bearing member. The toner particles are electrostatically held on the image-bearing member in a pattern corresponding to the latent image. Thereafter, a transfer system is provided to fix or transfer the toner image to electrostatically charged paper or other substrate medium by means known in the art.

The developing systems of electrophotographic machines can be characterized as either interactive or non-interactive. In an interactive developing system, a developer comprising toner particles and other components known in the art is caused to form a thin layer on a developer support member, such as a developer roller. The developer support brings the developer into contact with the entire surface of the image-bearing member. The toner particles are attracted by electrostatic forces to the latent image areas of the image-bearing member to form a toner image thereon.

Non-interactive or “jump” developing systems avoid contacting the entire surface of the image-bearing member with the developer. Instead, only toner particles are directed to the latent image areas on the surface of the image-bearing member. In operation, a thin layer of developer is held on a developer support in spaced relation with respect to the image-bearing surface. When the developer is carried to the developing region between the developer support and the image-bearing member, a bias voltage tends to exert an electrostatic force that causes the toner particles to “jump” a development gap between the developer roller and the image-bearing member and directs the toner particles toward the latent image areas on the surface of the image-bearing member. Once across the development gap, the toner particles tend to adhere electrostatically to the latent image areas on the surface of the image-bearing member to form a toner image.

The development gap must be of carefully controlled distances and dimensions, based on an applied bias voltage and other parameters, and must be uniform. If the development gap is too wide, for example, the toner particles will poorly adhere to the surface of the image-bearing member, resulting in decreased image density. If the development gap is too narrow, on the other hand, excessive toner particles can easily adhere to the surface of the image-bearing member, causing decreased image quality. For example, the toner image can include excessively thickened image features and, when the toner particles adhere to areas of the image-bearing member that should not be developed, fog.

Traditionally, spacer rollers are used to maintain the development gap between the developer roller and the image-bearing member. The spacer rollers are disposed on opposite ends of, and in axial alignment with, a shaft that supports the developer roller. Being configured to be pressed against and engage unused portions of the image-bearing member, the spacer rollers have a radius that is equal to a sum of a radius of the developer roller and the extent of the development gap. When the spacer roller is pressed against the unused portions of the image-bearing member, the developer roller is offset from the image-bearing member by a distance that is equal to the extent of the development gap. Further, as the image-bearing member rotates while forming the toner image, the spacer rollers also rotate, maintaining the extent of the development gap. The force exerted on the shaft to press the spacer rollers against the unused portions of the image-bearing member, however, can cause the shaft, and therefore the developer roller, to deform. For example, the shaft can deform from being substantially straight into a bow such that the development gap in the center of the developer roller is greater than the development gap at either end of the developer roller. This deformation destroys the uniformity of the development gap and decreases the image quality.

Thus, it would be desirable to provide a non-interactive, jump-type developing system utilizing a spacing device that is configured to maintain the development gap to the precise distances and dimensions without causing damage to the image-receiving member or the developer roller.

### SUMMARY OF THE INVENTION

The present invention is directed toward a spacing device for image processing systems that is configured to maintain a predetermined development gap formed between a developer roller and an image-receiving member to facilitate efficient development and to consistently maintain high image quality of an electrostatic image.

The image processing system in accordance with the present invention can comprise an image-receiving module, a developer cartridge, and a spacing device. The image-receiving module includes an image-receiving module housing and an image-receiving member, which is rotatably coupled with the image-receiving module housing. Similarly, the developer cartridge has a developer cartridge housing and a developer roller, and the developer roller is rotatably coupled with the developer cartridge housing. When the image processing system is properly assembled, the developer roller and the image-receiving member form a predetermined development gap. The spacing device is disposed substantially between, and is in communication with, the image-receiving module housing and the developer cartridge housing, preferably in a substantially stationary manner. Having a preselected length for sustaining a preselected distance between the image-receiving module housing and the developer cartridge housing, the spacing device is configured to maintain the development gap between the developer roller and the image-receiving member.

Other aspects and features of the present invention will become apparent from consideration of the following description taken in conjunction with the accompanying drawings.

### BRIEF DESCRIPTION OF THE DRAWINGS

FIG. 1A is a side view of one preferred embodiment of a spacing device for image processing systems in accordance with the present invention before a developer cartridge has been installed in the image processing system.

FIG. 1B is a top view of the spacing device of FIG. 1A.

FIG. 1C is the spacing device of FIGS. 1A-B after the developer cartridge has been installed in the image processing system.

FIG. 2 is an alternative embodiment of the spacing device of FIGS. 1A-C.

FIG. 3 is an alternative embodiment of the spacing device of FIGS. 1A-C.

FIG. 4A is a side view of one preferred embodiment of a spacing device for image processing systems in accordance with the present invention before a developer cartridge has been installed in the image processing system.

FIG. 4B is a top view of the spacing device of FIG. 4A.

FIG. 4C is the spacing device of FIGS. 4A-B after the developer cartridge has been installed in the image processing system.

FIG. 5 is an alternative embodiment of the spacing device of FIGS. 4A-C.

FIG. 6 is an alternative embodiment of the spacing device of FIGS. 4A-C.

FIG. 7A is a side view of one preferred embodiment of a spacing device for image processing systems in accordance with the present invention before a developer cartridge has been installed in the image processing system.

FIG. 7B is a top view of the spacing device of FIG. 7A.

FIG. 7C is the spacing device of FIGS. 7A-B after the developer cartridge has been installed in the image processing system.

FIG. 8A is a side view of one preferred embodiment of a spacing device for image processing systems in accordance with the present invention before a developer cartridge has been installed in the image processing system.

FIG. 8B is a top view of the spacing device of FIG. 8A.

FIG. 8C is the spacing device of FIGS. 8A-B after the developer cartridge has been installed in the image processing system.

FIG. 9A is a side view of one preferred embodiment of a spacing device for image processing systems in accordance with the present invention before a developer cartridge has been installed in the image processing system.

FIG. 9B is a top view of the spacing device of FIG. 9A.

FIG. 9C is the spacing device of FIGS. 9A-B after the developer cartridge has been installed in the image processing system.

It should be noted that the figures are not drawn to scale and that the figures are only intended to facilitate the description of the preferred embodiments of the present invention. The figures do not describe every aspect of the present invention and do not limit the scope of the invention.

### DETAILED DESCRIPTION OF THE PREFERRED EMBODIMENTS

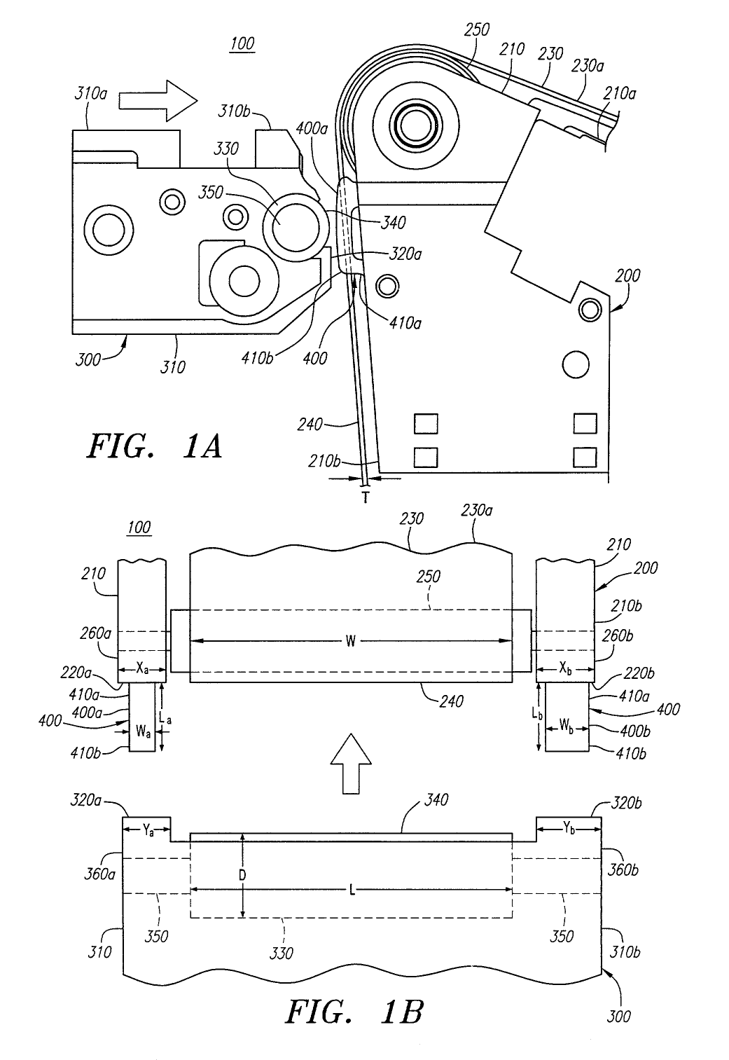

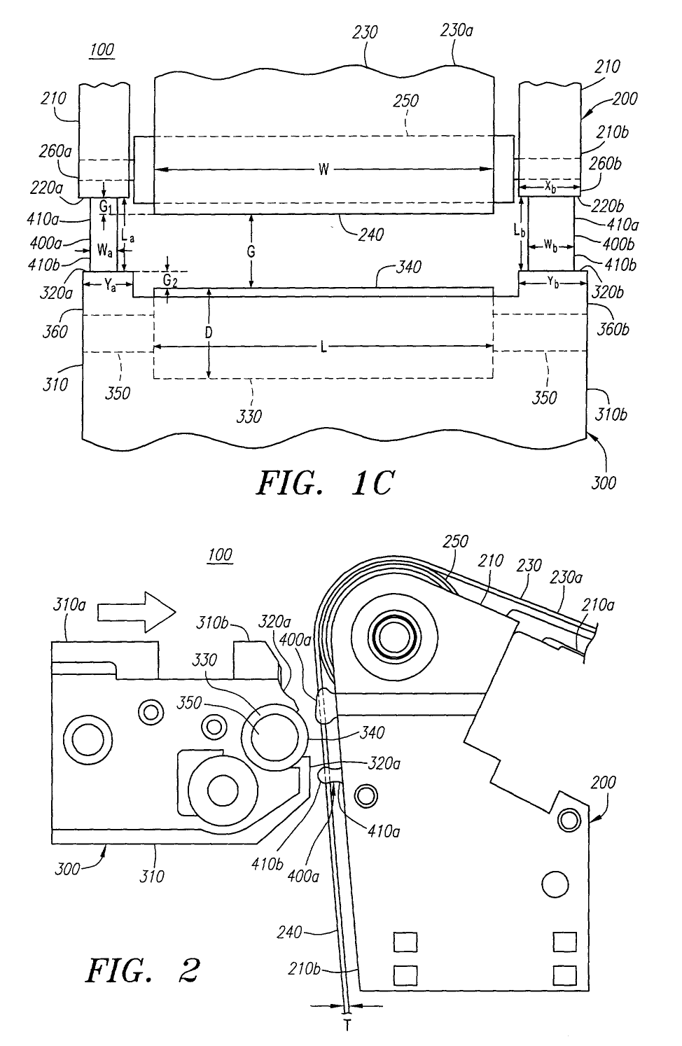

Since currently-used spacer rollers can damage developer rollers and can result in reduced image quality, a spacing device that can maintain a predetermined development gap between a developer roller and an image-receiving member without causing damage to the developer rollers and without reducing image quality is much more desirable and provides a basis for a wide range of image processing systems, such as photocopier systems and printer systems. This result can be achieved, according to one embodiment of the present invention, by employing an image processing system 100 as shown in FIGS. 1A-C. The image processing system 100 comprises an image-receiving module 200, at least one developer cartridge 300, and at least one spacing device 400.

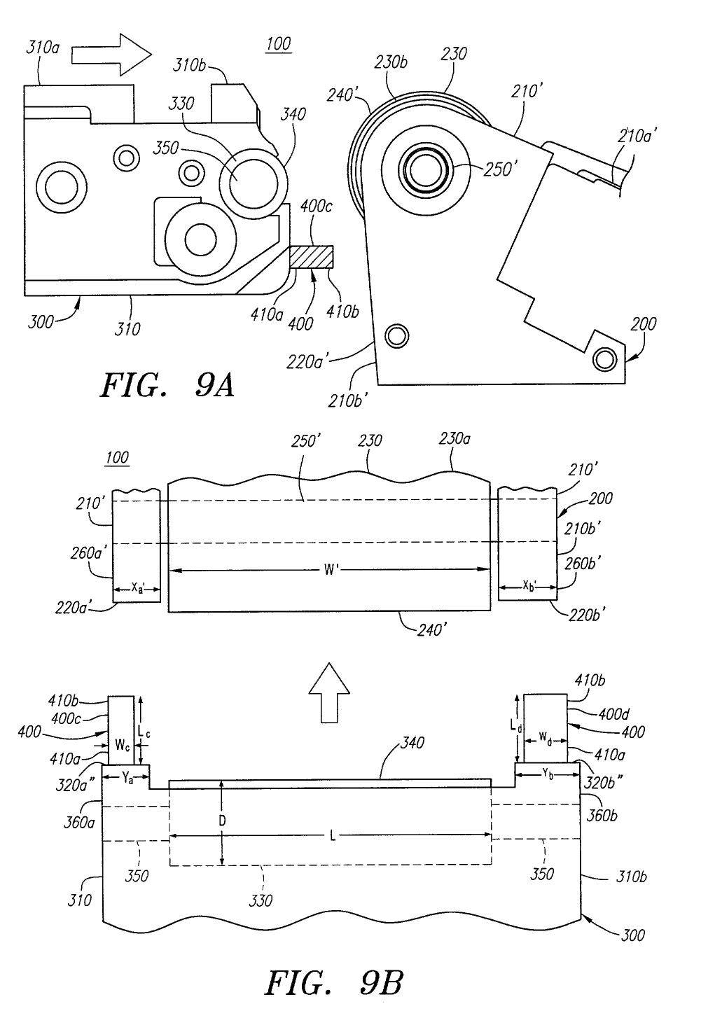

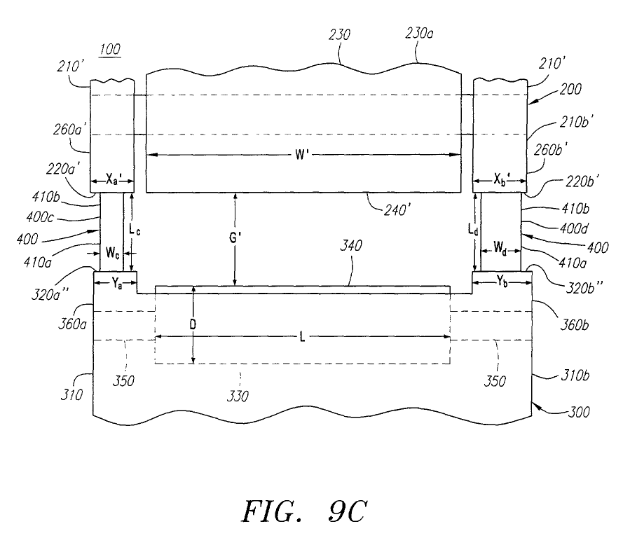

Comprising any type of image-receiving module known in the art, such as a photosensitive belt module or a photosensitive drum module, the image-receiving module 200 includes an image-receiving module housing 210 and an image-receiving member 230. The image-receiving module housing 210 has a proximal end region 210a and a distal end region 210b and can be formed in any manner and from any suitable module housing material, such as a plastic or a metal. Being rotatably coupled with the image-receiving module housing 210, the image-receiving member 230 is defined to comprise any type of image-receiving member or photoreceptor, such as a photosensitive belt 230a or a photosensitive drum 230b (shown in FIGS. 9A-C). The image-receiving member 230 can be disposed substantially within, and rotatably coupled with, the image-receiving module housing 210 in any manner known in the art such that the image-receiving member 230 can optically communicate from the distal end region 210b of the image-receiving module housing 210.

If the image-receiving member 230 comprises the photosensitive belt 230a as illustrated in FIGS. 1A-C, the photosensitive belt 230a can comprise any type of photosensitive belt and can have any belt width W and any belt thickness T. A typical belt thickness T, for example, is approximately one hundred microns. The photosensitive belt 230a can be rotatably coupled with the image-receiving module housing 210 substantially via one or more image-receiving rollers 250. Being configured to engage the photosensitive belt 230a, the image-receiving rollers 250 can comprise any type of image-receiving rollers and are disposed substantially between, and rotatably coupled with, a first housing member 260a and a second housing member 260b of the image-receiving module housing 210. The photosensitive belt 230a includes an imaging surface 240 and can be disposed on the image-receiving rollers 250 in any manner such that the imaging surface 240 is positioned substantially opposite the image-receiving module housing 210 as shown in FIGS. 1A-B.

The developer cartridge 300 can comprise any type of user-serviceable developer cartridge known in the art and includes a developer cartridge housing 310 and a developer roller 330. Being formed in any manner and from any suitable cartridge housing material, such as a plastic or a metal, the developer cartridge housing 310 can be configured to retain a predetermined volume of toner particles (not shown) and has a proximal end region 310a and a distal end region 310b. The toner particles can have any preselected color, such as cyan, yellow, magenta, or black, and are delivered via a developer roller periphery 340 of the developer roller 330. Although developer roller 330 can be formed with any suitable shape and dimension, the developer roller 330 preferably is substantially cylindrical and has a roller length L and a roller diameter D, which ranges between approximately two hundred and fifty microns and four hundred and fifty microns. The roller length L can comprise any length that is greater than or less than the belt width W of the photosensitive belt 230a but preferably is approximately equal to the belt width W of the photosensitive belt 230a.

The developer roller 330 can be disposed substantially within, and rotatably coupled with, the developer cartridge housing 310 in any manner such that the developer roller 330 can optically communicate from the distal end region 310b of the developer cartridge housing 310. For example, the developer roller 330 can be disposed substantially between a first housing member 360a and a second housing member 360b of the developer cartridge housing 310, and at least one coupling system 350, such as a ball bearing system, can rotatably couple the developer roller 330 with the first housing member 360a and the second housing member 360b. Although one developer cartridge 300 is illustrated and discussed with relation to FIGS. 1A-C for purposes of simplicity, it will be understood that the image processing system 100 can comprise a plurality of developer cartridges 300. For example, the preselected color of the toner particles retained within each of the developer cartridges 300 can be substantially uniform and/or different among the developer cartridges 300.

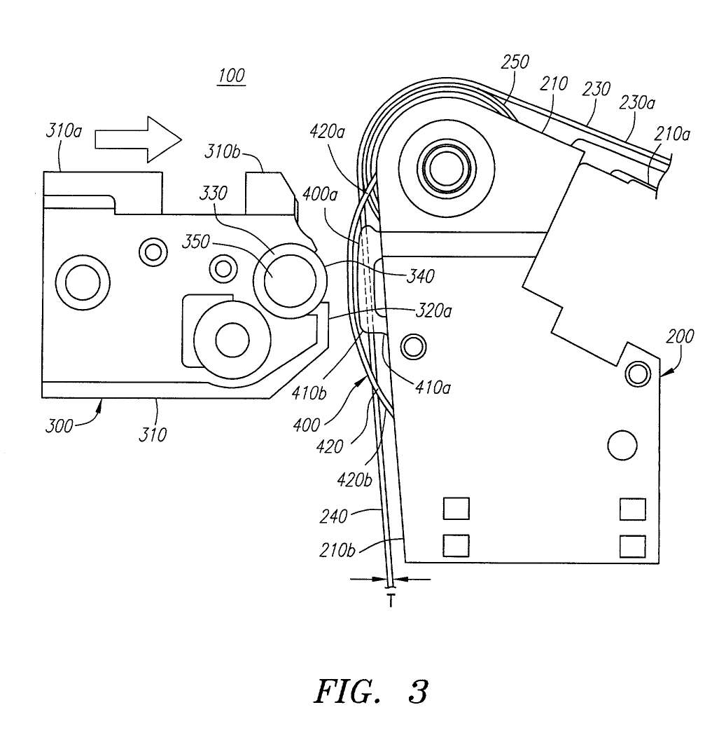

The spacing device 400 comprises one or more spacing members, such as a first spacing member 400a and a second spacing member 400b as shown in FIGS. 1A-B. The first spacing member 400a and the second spacing member 400b each can be manufactured with any shape and dimension and by any manufacturing process known in the art, such as stamping or molding. As desired, the spacing members can be formed as a hollow body as shown in FIG. 1A, a substantially solid body as shown in FIG. 2, or as a strap 420 as shown in FIG. 3. The first spacing member 400a and the second spacing member 400b respectively have preselected lengths La, Lb and preselected cross-sectional profiles Wa, Wb, each of which can be of any suitable dimension, and include proximal end regions 410a and an oppositely disposed distal end regions 410b. Although the cross-sectional profiles Wa, Wb preferably are substantially uniform, a cross-sectional profile of the proximal end region 410a can be greater than, equal to, or less than a cross-sectional profile of the distal end region 410b. The first spacing member 400a and the second spacing member 400b each are formed from a spacing member material, which preferably comprises any substantially rigid material, such as a plastic, a metal, nylon, polytetrafluoroethylene, or any type of polyfluorocarbon compound, that is well-known in the art. Preferably comprising substantially the same shape, dimension, and spacing member material, the first spacing member 400a and the second spacing member 400b can be provided with different shapes, dimensions, and/or spacing member materials, as desired.

Preferably being substantially fixedly coupled with the image-receiving module 200, the spacing device 400 can be configured to be coupled with the image-receiving module 200 in any manner and to extend from the image-receiving module 200 at any preselected angle. For example, the first spacing member 400a and the second spacing member 400b of the spacing device 400 can be respectively coupled in any manner, such as frictionally and/or adhesively, with the first housing member 260a and the second housing member 260b of the image-receiving module housing 210. One or more fasteners (not shown) of any kind also can be used to couple the first spacing member 400a and the second spacing member 400b with the first housing member 260a and the second housing member 260b, respectively. Preferably, the first spacing member 400a and the second spacing member 400b are formed from the module housing material of the image-receiving module housing 210. Stated somewhat differently, the first spacing member 400a, the second spacing member 400b, and the image-receiving module housing 210 preferably are formed as, and comprise, a single unit.

The proximal end region 410a of the first spacing member 400a is coupled with a coupling surface 220a of the first housing member 260a such that the distal end region 410b of the first spacing member 400a extends from the image-receiving module housing 210. Similarly, the proximal end region 410a of the second spacing member 400b is coupled with a coupling surface 220b of the second housing member 260b such that the distal end region 410b of the second spacing member 400b also extends from the image-receiving module housing 210. The first spacing member 400a and the second spacing member 400b preferably are substantially fixedly coupled with the first housing member 260a and the second housing member 260b, respectively. Although the cross-sectional profiles Wa, Wb of the spacing members 400a, 400b can be greater than predetermined cross-sectional profiles Xa, Xb of the respective housing members 260a, 260b, the cross-sectional profiles Wa, Wb preferably are less than or substantially equal to the cross-sectional profiles Xa, Xb, respectively, to inhibit interference with operation of the image processing system 100. If the spacing device 400 comprises the strap 420 as shown in FIG. 3, the strap 420 can include opposite ends 420a, 420b, which can be coupled with the image-receiving module 200 in any manner, such as frictionally, adhesively, or via one or more fasteners.

When the image-receiving module 200 and the developer cartridge 300 are properly installed in the image processing system 100 as shown in FIG. 1C, the distal end region 410b of the first spacing member 400a is configured to engage an engaging surface 320a of the first housing member 360a, and the distal end region 410b of the second spacing member 400b is configured to engage an engaging surface 320b of the second housing member 360b. Preferably being removably engaged with the housing members 360a, 360b, the distal end regions 410b of the respective spacing members 400a, 400b can engage the housing members 360a, 360b in any manner, including frictionally and/or adhesively, and preferably substantially fixedly engages the housing members 360a, 360b. The spacing members 400a, 400b preferably are removable engaged with the housing members 360a, 360b to permit the developer cartridge 300 to be removed and replaced when the predetermined volume of toner particles has been exhausted.

Although the cross-sectional profiles Wa, Wb of the spacing members 400a, 400b can be greater than predetermined cross-sectional profiles Ya, Yb of the respective housing members 360a, 360b, the cross-sectional profiles Wa, Wb preferably are less than or substantially equal to the cross-sectional profiles Ya, Yb, respectively, to inhibit interference with operation of the image processing system 100.

Referring again to FIG. 1C, when the image processing system is properly assembled, a predetermined development gap G also is formed between the imaging surface 240 of the photosensitive belt 230a and the developer roller periphery 340 of the developer roller 330. Typically being less than or substantially equal to two hundred and fifty microns, the development gap G can comprise any predetermined distance and preferably is within the range between approximately one hundred and twenty microns and one hundred and eighty microns, inclusive. The development gap G can be within any range of the predetermined distances, including, for example, any five-micron range, such as between one hundred and forty-five microns and one hundred and fifty microns, between substantially zero microns and two hundred and fifty microns. To facilitate efficient development and consistently maintain high image quality, the development gap G preferably is approximately uniform along the belt width W of the photosensitive belt 230a and the roller length L of the developer roller 330 and, once adjusted, preferably is maintained substantially at the predetermined dimension. Once the predetermined value of the development gap G has been determined, the first spacing member 400a and the second spacing member 400b are configured to substantially maintain the predetermined value and the approximate uniformity of the development gap G.

The development gap G inhibits the developer roller 330 from contacting the imaging surface 240 of the photosensitive belt 230a and is associated with a preselected bias voltage, which can be within any voltage range. For example, when the development gap G is within the range between approximately one hundred and twenty microns and one hundred and eighty microns, the bias voltage typically ranges substantially between four hundred volts and eight hundred volts, inclusively. The bias voltage can be within any preselected voltage range, including, for example, any five-volt range, such as between five hundred and ninety-five volts and six hundred volts, between substantially between four hundred volts and eight hundred volts. The bias voltage is configured to exert an electrostatic force that causes the toner particles from the developer cartridge 300 to “jump” from the developer roller 330, across the development gap G, and toward the imaging surface 240. Upon crossing the development gap G, the toner particles can adhere electrostatically to the imaging surface 240 to form an electrostatic image (not shown). When the bias voltage is within a preselected voltage range, the development gap G likewise should be maintained substantially within an associated range of the predetermined distances to efficiently develop, and consistently maintains high image quality of, the electrostatic image.

The preselected length La of the first spacing member 400a and the preselected length Lb of the second spacing member 400b each can be determined in any manner. For example, the preselected length La of the first spacing member 400a can be determined by examining a distance GI between the coupling surface 220a of the first housing member 260a and the imaging surface 240 and a distance G2 between the engaging surface 320a of the first housing member 360a and the developer roller periphery 340. The distances G1 and G2, each of which can comprise a positive distance or a negative distance, are added to the predetermined value of the development gap G to determine the preselected length La of the first spacing member 400a. The distance G1 comprises a positive distance if the imaging surface 240 extends beyond the coupling surface 220a as shown in FIG. 1C; otherwise, the distance G1 comprises a negative distance. Similarly, if the developer roller periphery 340 extends beyond the engaging surface 320a, the distance G2 comprises a positive distance; otherwise, as illustrated in FIG. 1C, the distance G2 comprises a negative distance. If the predetermined value of the development gap G is approximately one hundred and fifty microns, the imaging surface 240 extends beyond the coupling surface 220a by approximately one hundred and ten microns, and the engaging surface 320a extends beyond the developer roller periphery 340 by approximately eighty microns, for example, the preselected length La of the first spacing member 400a is approximately equal to one hundred and eighty microns. The preselected length Lb of the second spacing member 400b can be determined in a manner that is similar to the manner used to determine the preselected length La.

The first spacing member 400a and the second spacing member 400b therefore maintain the development gap G between the imaging surface 240 and the developer roller periphery 340 and preferably remains substantially stationary during operation of the image processing system 100. Through use of the spacing device 400, the development gap G remains substantially constant and approximately uniform along a belt width W of the photosensitive belt 230a and a roller length L of the developer roller 330 without damage to the image-receiving module 200 and/or the developer cartridge 300. Thereby, the image processing system 100 can efficiently develop, and consistently maintains high image quality for, electrostatic images.

In operation, the image processing system 100 includes the image-receiving module 200 with the image-receiving module housing 210 and the image-receiving member 230. The image-receiving member 230 is rotatably coupled with the image-receiving module housing 210, and the spacing members 400a, 400b are coupled with the image-receiving module housing 210 in the manner described in more detail above. The image processing system 100 also is configured to receive the developer cartridge 300. In the manner described in more detail above, the developer cartridge 300 has the developer cartridge housing 310 and the developer roller 330, which is rotatably coupled with the developer cartridge housing 310. As the developer cartridge 300 is received by the image processing system 100, the distal end region 310b of the developer cartridge housing 310 is disposed substantially adjacently to the distal end region 210b of the image-receiving module housing 210. The developer cartridge 300 continues to be received until the distal end regions 310b of the spacing members 400a, 400b respectively contact the engaging surfaces 320a, 320b of the developer cartridge 300. When the spacing members 400a, 400b respectively contact the engaging surfaces 320a, 320b of the developer cartridge 300, the development gap G is formed substantially between the image-receiving member 230 and the developer roller 330. Preferably being substantially stationary during operation of the image processing system 100, the spacing members 400a, 400b remain in contact with the image-receiving module 200 and the developer cartridge 300 until the developer cartridge 300 is subsequently removed from the image processing system 100, thereby maintaining the development gap G.

It will be appreciated that the spacing device 400 can comprise a plurality of first spacing members 400a (as shown in FIG. 2) and/or a plurality of second spacing members 400b. Being manufactured in any manner, such as via the manner described above with respect to the first spacing member 400a and the second spacing member 400b (shown in FIGS. 1A-B), the plurality of first spacing members 400a and/or second spacing members 400b can be arranged in any manner, such as in one or more rows and/or columns. The plurality of first spacing members 400a can be coupled with, and extend from, the image-receiving module 200 in any manner, such as via one or more coupling surfaces 220a in the manner described in more detail above with respect to the first spacing member 400a. Similarly, in the manner described in more detail above with respect to the second spacing member 400b, the plurality of second spacing members 400b can be coupled with, and extend from, the image-receiving module 200 in any manner, such as via one or more coupling surfaces 220b. When the image processing system is properly assembled, a plurality of first spacing members 400a and/or second spacing members 400b is configured to engage one or more engaging surfaces 320a and/or engaging surfaces 320b of the developer cartridge 300 in the manner described in more detail above such that development gap G remains substantially constant and approximately uniform.

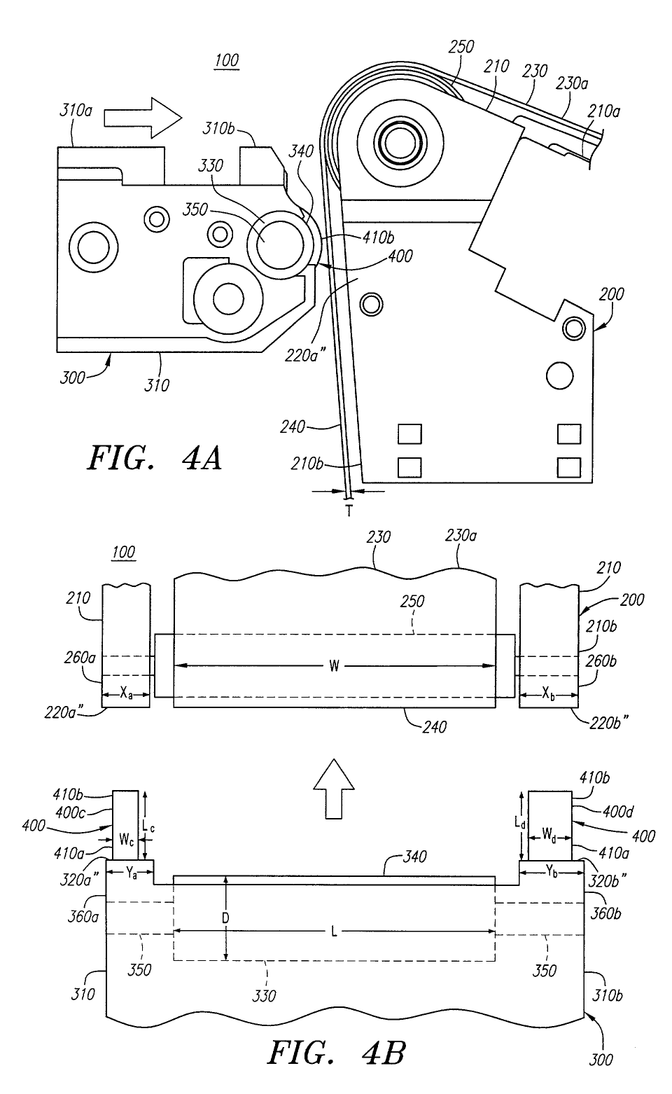

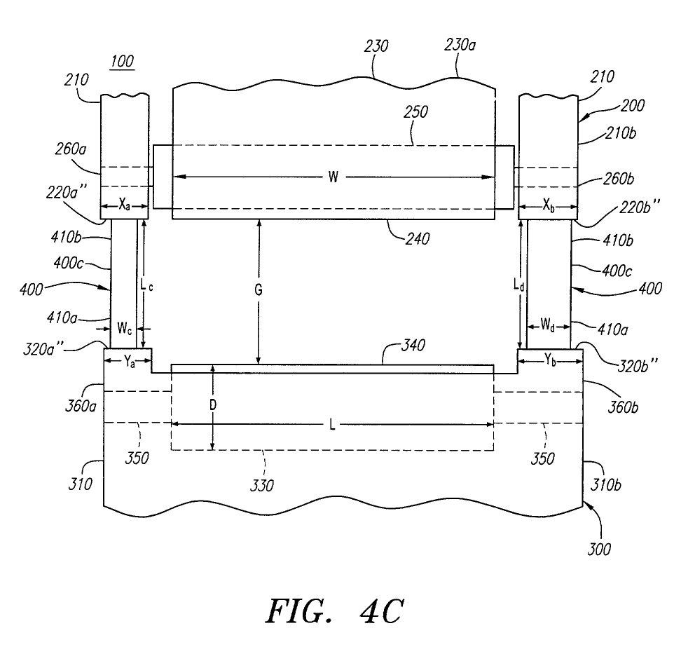

Another embodiment of a spacing device 400 in accordance with the present invention is illustrated in FIGS. 4A-C. In this embodiment, the spacing device 400 is configured to be coupled with a developer cartridge 300 of an image processing system 100. The image processing system 100 comprises an image-receiving module 200 and at least one developer cartridge 300, each of which is produced in the manner described in more detail above with reference to FIGS. 1A-C. As was discussed in more detail above, the image-receiving module 200 includes an image-receiving module housing 210 and an image-receiving member 230, such as a photosensitive belt 230a or a photosensitive drum 230b (shown in FIGS. 9A-C), which is rotatably coupled with the image-receiving module housing 210. The developer cartridges 300 each include a developer cartridge housing 310 and a developer roller 330 with a developer roller periphery 340. The developer roller 330 is rotatably coupled with the developer cartridge housing 310. Although one developer cartridge 300 is illustrated and discussed with relation to FIGS. 4A-C for purposes of simplicity, it will be understood that the image processing system 100 can comprise a plurality of developer cartridges 300.

Being provided in the manner described in more detail above with reference to FIGS. 1A-C, the spacing device 400 comprises one or more spacing members, such as a third spacing member 400c and a fourth spacing member 400d as shown in FIGS. 4A-B. As desired, the spacing members can be formed as a hollow body, a substantially solid body as shown in FIGS. 4A-B, or as a strap 430 as shown in FIG. 6. Being formed from a spacing member material, the third spacing member 400c and the fourth spacing member 400d respectively have preselected lengths Lc, Ld and preselected cross-sectional profiles Wc, Wd, each of which can be of any suitable dimension, and include proximal end regions 410a and an oppositely disposed distal end regions 410b in the manner described in more detail above. Preferably comprising substantially the same shape, dimension, and spacing member material, the third spacing member 400c and the fourth spacing member 400d can be provided with different shapes, dimensions, and/or spacing member materials, as desired.

Preferably being substantially fixedly coupled with the developer cartridge 300, the spacing device 400 can be configured to be coupled with the developer cartridge 300 in any manner and to extend from the developer cartridge 300 at any preselected angle in the manner described in more detail above. For example, the developer cartridge housing 310 can include a first housing member 360a and a second housing member 360b as was described in more detail above, and the third and fourth spacing members 400c, 400d of the spacing device 400 can be respectively coupled in any manner with the first and second housing members 360a, 360b. Preferably, the third spacing member 400c and the fourth spacing member 400d are formed from a cartridge housing material of the developer cartridge housing 310. Stated somewhat differently, the third spacing member 400c, the fourth spacing member 400d, and the developer cartridge housing 310 preferably are formed as, and comprise, a single unit.

The proximal end region 410a of the third spacing member 400c is coupled with a coupling surface 320a″ of the first housing member 360a such that the distal end region 410b of the third spacing member 400c extends from the developer cartridge housing 310. Similarly, the proximal end region 410a of the fourth spacing member 400d is coupled with a coupling surface 320b″ of the second housing member 360b such that the distal end region 410b of the fourth spacing member 400d also extends from the developer cartridge housing 310. The third spacing member 400c and the fourth spacing member 400d preferably are substantially fixedly coupled with the first housing member 360a and the second housing member 360b, respectively. If the spacing device 400 comprises the strap 430 as shown in FIG. 6, the strap 430 can include opposite ends 430a, 430b, which can be coupled with the developer cartridge 300 in any manner, including the manner described above in which the strap 420 (shown in FIG. 3) is coupled with the image-receiving module 200.

When the image-receiving module 200 and the developer cartridge 300 are properly installed as shown in FIG. 4C, a predetermined development gap G is formed between the imaging surface 240 and the developer roller periphery 340 as was described in more detail above with reference to FIG. 1C. The development gap G can comprise any predetermined distance and preferably is substantially within one or more of the ranges as defined above with respect to the development gap G (shown in FIG. 1C). In the manner described in more detail above with respect to the spacing members 400a, 400b, the spacing members 400c, 400d are configured to substantially maintain the development gap G. The distal end region 410b of the third spacing member 400c is configured to engage an engaging surface 220a″ of the first housing member 260a. The distal end region 410b of the fourth spacing member 400d likewise is configured to engage an engaging surface 220b″ of the second housing member 260b. Preferably substantially fixedly engaging the housing members 260a, 260b, the spacing members 400c, 400d can respectively engage the engaging surfaces 220a″, 220b″ in any manner, such at the manner in which the spacing members 400a, 400b respectively engaged the engaging surfaces 320a, 320b as described in more detail above with reference to FIG. 1C. The preselected lengths Lc, Ld of the spacing members 400c, 400d each can be determined in any manner, including the manner described in more detail above with respect to the preselected lengths La, Lb of the spacing members 400a, 400b. Also in the manner described in more detail above with respect to the spacing members 400a, 400b (shown in FIGS. 1A-C), the cross-sectional profiles Wc, Wd of the spacing members 400c, 400d can be respectively greater than, less than, or substantially equal to predetermined cross-sectional profiles Xa, Xb of the respective housing members 260a, 260b and/or predetermined cross-sectional profiles Ya, Yb of the respective housing members 360a, 360b.

In the manner described in more detail above with respect to the spacing members 400a, 400b, the spacing members 400c, 400d therefore are configured to maintain the development gap G between the imaging surface 240 and the developer roller periphery 340 and preferably remains substantially stationary during operation of the image processing system 100. Through use of the spacing device 400, the development gap G remains substantially constant and approximately uniform along a belt width W of the photosensitive belt 230a and a roller length L of the developer roller 330 without damage to the image-receiving module 200 and/or the developer cartridge 300. Thereby, the image processing system 100 can efficiently develop, and consistently maintains high image quality for, electrostatic images.

It will be appreciated that an image processing system 100 can include an image-receiving module 200, a first developer cartridge 300, and a first spacing device 400, which is coupled with the first developer cartridge 300 and which is provided in the manner described in more detail above with respect to the spacing members 400c, 400d. When a predetermined volume of toner particles within the first developer cartridge 300 has been exhausted, the first developer cartridge 300 can be removed from the image processing system 100, and a second developer cartridge 300 can be received by the processing system 100. The second developer cartridge 300 can include a predetermined volume of toner particles and can be coupled with a second spacing device 400, which is provided in the manner described above with respect to the first spacing device 400. When the second developer cartridge 300 is properly installed in the image processing system 100, the second spacing device 400 is configured to engage the image-receiving module 200, thereby maintaining a predetermined development gap G between an image-receiving member 230 of the image-receiving module 200 and a developer roller 330 of the second developer cartridge 300. The development gap G can comprise any predetermined distance and preferably is substantially within one or more of the ranges as defined above with respect to the development gap G (shown in FIG. 1C).

It also will be appreciated that the spacing device 400 of the present invention can be configured for use with an image processing system 100 that includes a plurality of developer cartridges 300. For example, the image processing system 100 can comprise an image-receiving module 200 and a plurality of spacing members (not shown), each spacing member being provided in the manner described in more detail above with respect to the spacing members 400c, 400d. The plurality of spacing members are configured to be coupled with the plurality of developer cartridges 300 in the manner described above and are configured to maintain a predetermined development gap G between an image-receiving member 230 of the image-receiving module 200 and a developer roller 330 of each respective developer cartridge 300. Each of the development gaps G can comprise any predetermined distance and preferably is substantially within one or more of the ranges as defined above with respect to the development gap G (shown in FIG. 1C).

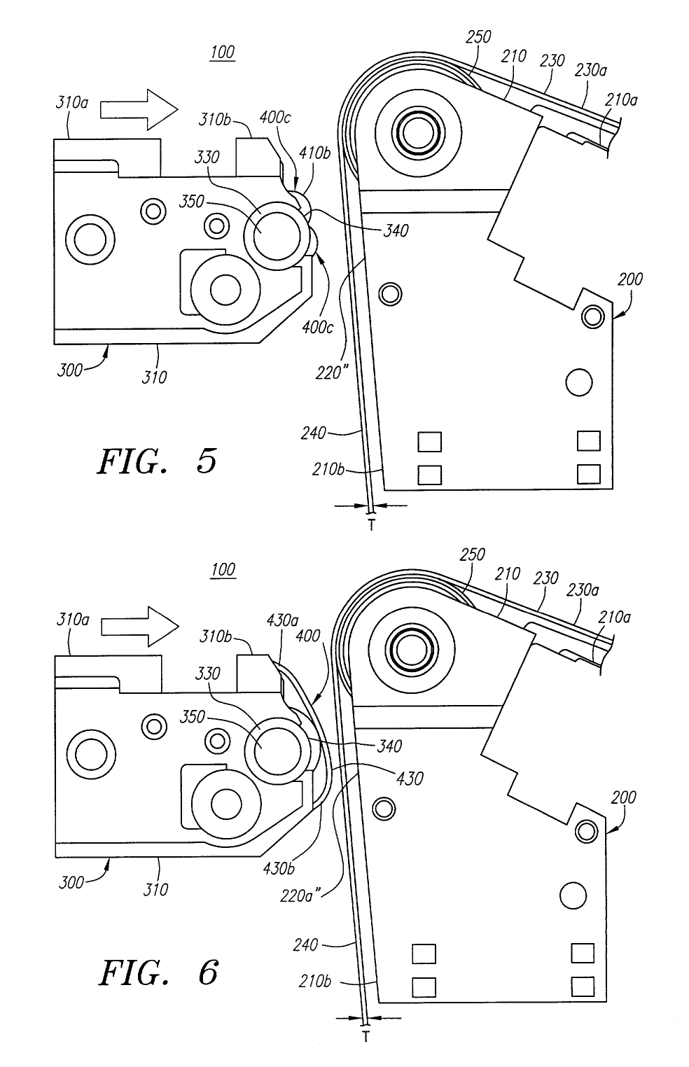

It further will be appreciated that the spacing device 400 can comprise a plurality of third spacing members 400c (as shown in FIG. 5) and/or a plurality of fourth spacing members 400d. Being manufactured in any manner, such as via the manner described above with respect to the third spacing member 400c and the fourth spacing member 400d (shown in FIGS. 4A-B), the plurality of third spacing members 400c and/or fourth spacing members 400d can be arranged in any manner, such as in one or more rows and/or columns. The plurality of third spacing members 400c can be coupled with, and extend from, the developer cartridge 300 in any manner, such as via one or more coupling surfaces 320a″ in the manner described in more detail above with respect to the third spacing member 400c. Similarly, in the manner described in more detail above with respect to the fourth spacing member 400d, the plurality of fourth spacing members 400d can be coupled with, and extend from, the developer cartridge 300 in any manner, such as via one or more coupling surfaces 320b″. When the image processing system is properly assembled, plurality of third spacing members 400c and/or fourth spacing members 400d is configured to engage one or more engaging surfaces 220a″ and/or engaging surfaces 220b″ of the image-receiving module 200 in the manner described in more detail above such that the development gap G remains substantially constant and approximately uniform.

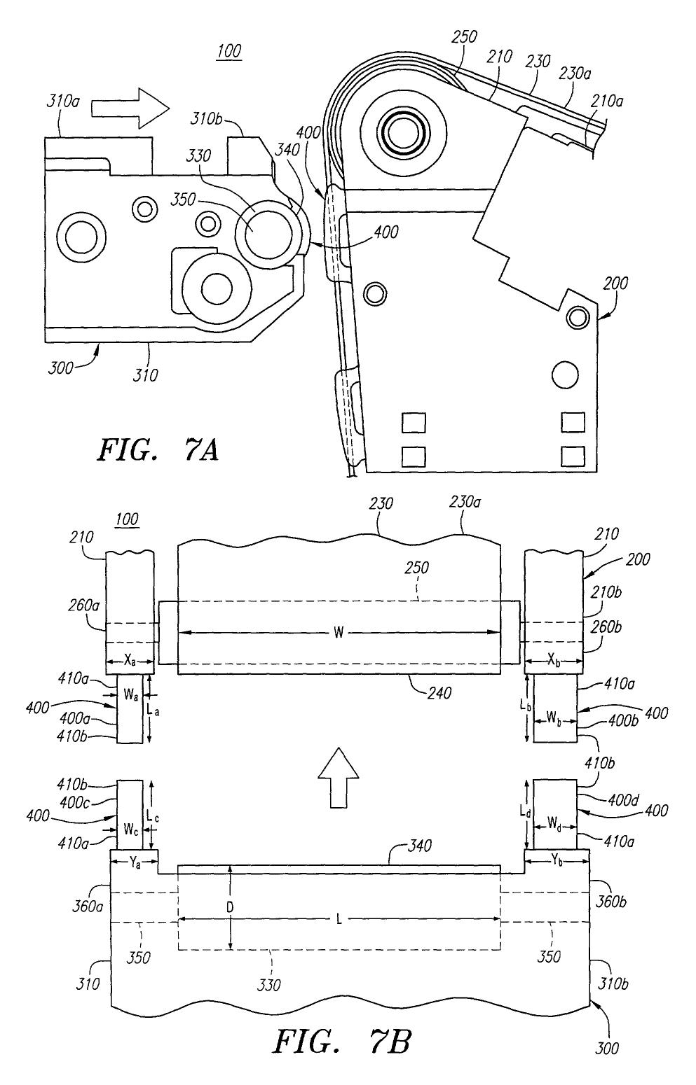

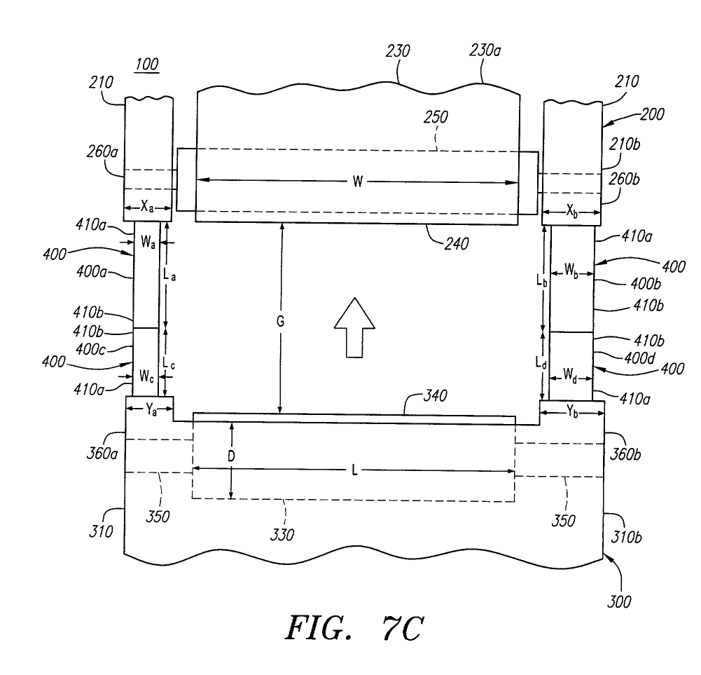

Another embodiment of a spacing device 400 in accordance with the present invention is illustrated in FIGS. 7A-C. In this embodiment, the spacing device 400 includes a first arrangement of one or more spacing members, such as spacing members 400a, 400b, and a second arrangement of one or more spacing members, such as spacing members 400c, 400d, which are configured to be coupled with an image-receiving module 200 and a developer cartridge 300, respectively, of an image processing system 100. The image-receiving module 200 and the developer cartridge 300 are produced in the manner described in more detail above with reference to FIGS. 1A-C. As was discussed in more detail above, the image-receiving module 200 includes an image-receiving module housing 210 and an image-receiving member 230, such as a photosensitive belt 230a or a photosensitive drum 230b (shown in FIGS. 9A-C), which is rotatably coupled with the image-receiving module housing 210. The developer cartridges 300 each include a developer cartridge housing 310 and a developer roller 330 with a developer roller periphery 340. The developer roller 330 is rotatably coupled with the developer cartridge housing 310. Although one developer cartridge 300 is illustrated and discussed with relation to FIGS. 7A-C for purposes of simplicity, it will be understood that the image processing system 100 can comprise a plurality of developer cartridges 300.

The first arrangement of spacing members can comprise the first spacing member 400a and the second spacing member 400b, which are provided in the manner described in more detail above with reference to FIGS. 1A-C. Being formed from a spacing member material, the spacing members 400a, 400b respectively have preselected lengths La, Lb and preselected cross-sectional profiles Wa, Wb, each of which can be of any suitable dimension, and include proximal end regions 410a and an oppositely disposed distal end regions 410b in the manner described in more detail above. As desired, the spacing members 400a-b can be provided with substantially uniform and/or different shapes, dimensions, and/or spacing member materials, as desired. Preferably being substantially fixedly coupled with the image-receiving module 200, the spacing members 400a-b can be configured to be coupled with the image-receiving module 200 in any manner, such as via respective housing members 260a, 260b, and to extend from the image-receiving module 200 at any preselected angle in the manner described in more detail above. As was discussed in more detail above with reference to FIGS. 1A-C, the spacing members 400a-b preferably are formed from a module housing material of the image-receiving module 200.

Similarly, the second arrangement of spacing members can comprise the third spacing member 400c and the fourth spacing member 400d and can be provided in the manner described in more detail above with reference to FIGS. 4A-C. Being formed from a spacing member material, the spacing members 400c, 400d respectively have preselected lengths Lc, Ld and preselected cross-sectional profiles Wc, Wd, each of which can be of any suitable dimension, and include proximal end regions 410a and an oppositely disposed distal end regions 410b in the manner described in more detail above. As desired, the spacing members 400c-d can be provided with substantially uniform and/or different shapes, dimensions, and/or spacing member materials. Preferably being substantially fixedly coupled with the developer cartridge 300, the spacing members 400c-d can be configured to be coupled with the developer cartridge 300 in any manner, such as via respective housing members 360a, 360b, and to extend from the developer cartridge 300 at any preselected angle in the manner described in more detail above. As was discussed in more detail above with reference to FIGS. 4A-C, the spacing members 400c-d preferably are formed from a cartridge housing material of the developer cartridge 300.

When the image-receiving module 200 and the developer cartridge 300 are properly installed as shown in FIG. 7C, a predetermined development gap G is formed between the imaging surface 240 and the developer roller periphery 340 as was described in more detail above with reference to FIG. 1C. The development gap G can comprise any predetermined distance and preferably is substantially within one or more of the ranges as defined above with respect to the development gap G (shown in FIG. 1C). In the manner described in more detail above, the spacing members 400a, 400b and the spacing members 400c, 400d are configured to substantially maintain the development gap G. The distal end region 410b of the first spacing member 400a is configured to engage the distal end region 410b of the third spacing member 400c, and the distal end region 410b of the second spacing member 400b is configured to engage the distal end region 410b of the fourth spacing member 400d. Preferably being substantially fixedly engaged, the spacing members 400a, 400b can respectively engage the spacing members 400c, 400d in any manner, such at the manner in which the spacing members 400a, 400b respectively engaged the engaging surfaces 320a, 320b as described in more detail above with reference to FIG. 1C. In the manner described in more detail above, the cross-sectional profiles Wa, Wb of the spacing members 400a, 400b can be respectively greater than, less than, or substantially equal to predetermined cross-sectional profiles Xa, Xb of the respective housing members 260a, 260b. Similarly, the cross-sectional profiles Wc, Wd of the spacing members 400c, 400d can be respectively greater than, less than, or substantially equal to predetermined cross-sectional profiles Ya, Yb of the respective housing members 360a, 360b.

The preselected lengths La, Lb of the spacing members 400a, 400b and the preselected lengths Lc, Ld of the spacing members 400c, 400d each can be determined in any manner. For example, since the first spacing member 400a and the third spacing member 400c are disposed lengthwise between the image-receiving module 200 and the one developer cartridge 300, a sum of the length La and the length Lc is substantially equal to a relevant distance, such as between the housing member 260a and the housing member 360a. The relevant distance can be determined in any manner, such as the manner described in more detail above with respect to the preselected lengths La, Lb as shown in FIG. 1C, and the length Lc is substantially equal to a difference between the relevant distance and the length La. The relevant distance can be allocated between the first spacing member 400a and the third spacing member 400c in any manner; for example, the relevant distance can be substantially equally divided between the first spacing member 400a and the third spacing member 400c. As desired, the preselected length Lb of the second spacing member 400b and the preselected length Ld of the fourth spacing member 400d can be determined as with the preselected lengths La, Lc.

Therefore, in the manner described above, the spacing members 400a-d are configured to maintain the development gap G between the imaging surface 240 and the developer roller periphery 340 and preferably remains substantially stationary during operation of the image processing system 100. Through use of the spacing device 400, the development gap G remains substantially constant and approximately uniform along a belt width W of the photosensitive belt 230a and a roller length L of the developer roller 330 without damage to the image-receiving module 200 and/or the developer cartridge 300. Thereby, the image processing system 100 can efficiently develop, and consistently maintains high image quality for, electrostatic images.

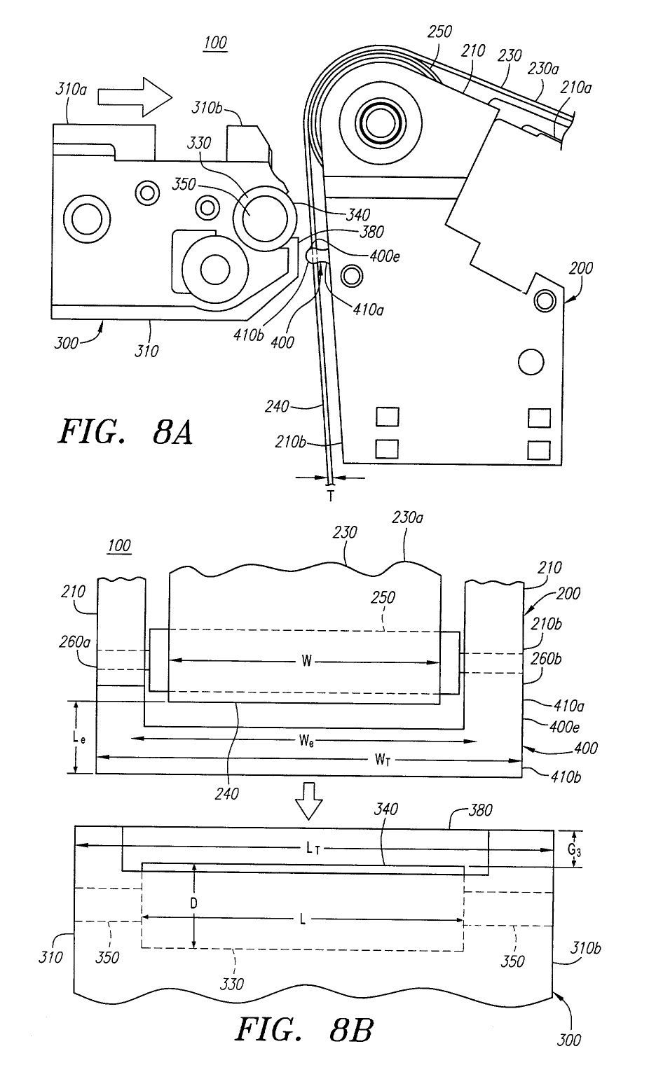

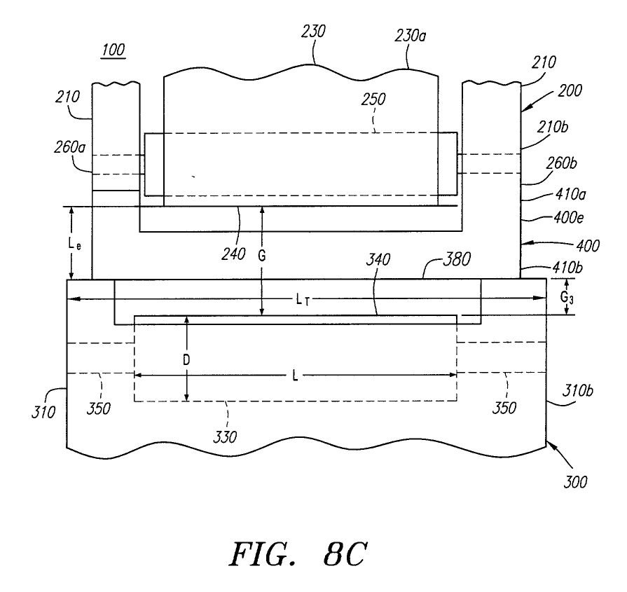

Another embodiment of a spacing device 400 in accordance with the present invention is illustrated in FIGS. 8A-C. In this embodiment, the spacing device 400 is configured to be coupled with an image-receiving module 200 of an image processing system 100 and to extend partially or substantially completely across a module width W_{T} of an image-receiving member 230 of the image-receiving module 200. The image processing system 100 comprises the image-receiving module 200 and at least one developer cartridge 300, each of which is produced in the manner described in more detail above with reference to FIGS. 1A-C. As was discussed in more detail above, the image-receiving module 200 includes an image-receiving module housing 210, and the image-receiving member 230 is rotatably coupled with the image-receiving module housing 210 and can comprise any type of image-receiving member, such as a photosensitive belt 230a or a photosensitive drum 230b (shown in FIGS. 9A-C). The developer cartridges 300 each include a developer cartridge housing 310 and a developer roller 330 with a developer roller periphery 340. The developer roller 330 is rotatably coupled with the developer cartridge housing 310. Although one developer cartridge 300 is illustrated and discussed with relation to FIGS. 4A-C for purposes of simplicity, it will be understood that the image processing system 100 can comprise a plurality of developer cartridges 300.

The spacing device 400 can comprise one or more spacing members, such as a fifth spacing member 400e, as shown in FIGS. 8A-B. As desired, the fifth spacing member 400e can be formed in any manner, such as the manner described in more detail above with respect to the spacing members 400a, 400b (shown in FIGS. 1A-C). Being formed from a spacing member material, the fifth spacing member 400e has a preselected length Le and preselected cross-sectional profile We, each of which can be of any suitable dimension. As desired, the cross-sectional profile We can be substantially uniform and/or vary along the length Le, and the fifth spacing member 400e includes a proximal end region 410a and an oppositely disposed distal end region 410b. Preferably being substantially fixedly coupled with the image-receiving module 200, the fifth spacing member 400e can be configured to be coupled with the image-receiving module 200 in any manner, such as via a first housing member 360a and/or a second housing member 360b. For example, the proximal end region 410a of the fifth spacing member 400e can be coupled with the image-receiving module housing 210 such that the distal end region 410b of the fifth spacing member 400e extends from the image-receiving module housing 210 at any preselected angle. The fifth spacing member 400e preferably is formed from a module housing material of the image-receiving module housing 210 in the manner described in more detail above with respect to the spacing members 400a, 400b.

When the image-receiving module 200 and the developer cartridge 300 are properly installed as shown in FIG. 8C, a predetermined development gap G is formed between the imaging surface 240 and the developer roller periphery 340 as was described in more detail above with reference to FIG. 1C. The development gap G can comprise any predetermined distance and preferably is substantially within one or more of the ranges as defined above with respect to the development gap G (shown in FIG. 1C). In the manner described in more detail above with respect to the spacing members 400a, 400b, the fifth spacing member 400e is configured to substantially maintain the development gap G, and the distal end region 410b of the fifth spacing member 400e is configured to engage an engaging surface 380 provided on the developer cartridge housing 310. The engaging surface 380 can have any suitable dimension and can extend partially or substantially completely across a cartridge width L_{T}of the developer cartridge 300. Preferably substantially fixedly engaging the engaging surface 380, the fifth spacing member 400e can engage the engaging surfaces 220a″, 220b″ in any manner, such at the manner in which the spacing members 400a, 400b respectively engaged the engaging surfaces 320a, 320b as described in more detail above with reference to FIG. 1C. In the manner described in more detail above with respect to the spacing members 400a, 400b, the cross-sectional profile We of the fifth spacing member 400e can be respectively greater than, less than, or substantially equal to a predetermined cross-sectional profile (not shown) of the engaging surface 380. For example, a width of the cross-sectional profile We can be greater than, less than, or substantially equal to the module width W_{T} and/or the cartridge width L_{T}.

The preselected length Le of the fifth spacing member 400e can be determined in any manner, including the manner described in more detail above with respect to the preselected lengths La, Lb of the spacing members 400a, 400b. For example, the preselected length Le can be determined by examining a distance G3 between the engaging surface 380 of the developer cartridge 300 and the developer roller periphery 340. The distance G3 can comprise a positive distance or a negative distance, such that, if the developer roller periphery 340 extends beyond the engaging surface 320a, the distance G3 comprises a positive distance as shown in FIG. 8C. Otherwise, the distance G3 comprises a negative distance. To determine the preselected length Le of the fifth spacing member 400e, the distance G3 is added to the predetermined value of the development gap G. Therefore, if the predetermined value of the development gap G is approximately one hundred and fifty microns and the engaging surface 380 extends beyond the developer roller periphery 340 by approximately eighty microns, for example, the preselected length Le of the fifth spacing member 400e is approximately equal to seventy microns such that the sum of the values for the distance G3 by which the engaging surface 380 extends beyond the developer roller periphery 340 and the length of the fifth spacing member 400e is substantially equal to the predetermined distance of the development gap G.

Therefore, in the manner described in more detail above with respect to the spacing members 400a, 400b, the fifth spacing member 400e is configured to maintain the development gap G between the imaging surface 240 and the developer roller periphery 340 and preferably remains substantially stationary during operation of the image processing system 100. Through use of the spacing device 400, the development gap G remains substantially constant and approximately uniform along a belt width W of the photosensitive belt 230a and a roller length L of the developer roller 330 without damage to the image-receiving module 200 and/or the developer cartridge 300. Thereby, the image processing system 100 can efficiently develop, and consistently maintains high image quality for, electrostatic images.

It will be appreciated that the spacing device 400 can comprise a plurality of fifth spacing devices 400e. It also will be appreciated that one or more spacing devices 400, each being provided substantially in the manner described in more detail above with regard to the fifth spacing member 400e, can be configured to be coupled with the developer cartridge 300 and to substantially maintain the development gap G by engaging an engaging surface (not shown) of the image-receiving module 200. It will be further understood that the spacing device 400 of the present invention can comprise any arrangement and/or combination of the above-mentioned spacing devices and/or members, including one or more of the spacing members 400a-e.

It will be further appreciated that the spacing device 400 of the present invention can be configured to operate with any kind of image-receiving module 200. To illustrate that the spacing device 400 can be configured for use with any kind of image-receiving module 200, another embodiment of a spacing device 400 in accordance with the present invention is shown in FIGS. 9A-C. This embodiment is substantially the same as the embodiment illustrated in FIGS. 4A-C with a significant difference being that the image-receiving module 200 comprises a photosensitive drum module rather than a photosensitive belt module. The image processing system 100 comprises an image-receiving module 200 and at least one developer cartridge 300, which is produced in the manner described in more detail above with reference to FIGS. 1A-C. As was discussed in more detail above, the image-receiving module 200 includes an image-receiving module housing 210′ and an image-receiving member 230, such as a photosensitive belt 230a (shown in FIGS. 1A-C) or a photosensitive drum 230b, which is rotatably coupled with the image-receiving module housing 210′. The image-receiving module housing 210′ has a proximal end region 210a′ and a distal end region 210b′ and can be formed in any manner and from any suitable module housing material, such as a plastic or a metal. The developer cartridges 300 each include a developer cartridge housing 310 and a developer roller 330 with a developer roller periphery 340. The developer roller 330 is rotatably coupled with the developer cartridge housing 310. Although one developer cartridge 300 is illustrated and discussed with relation to FIGS. 4A-C for purposes of simplicity, it will be understood that the image processing system 100 can comprise a plurality of developer cartridges 300.

If the image-receiving member 230 comprises the photosensitive drum 230b as illustrated in FIGS. 9A-C, the photosensitive drum 230b can comprise any type of photosensitive drum and can have any drum width W′. The photosensitive drum 230b can be rotatably coupled with the image-receiving module housing 210′ substantially via one or more image-receiving rollers 250′. Being configured to engage the photosensitive drum 230b, the image-receiving rollers 250′ can comprise any type of image-receiving rollers and are disposed substantially between, and rotatably coupled with, a first housing member 260a′ and a second housing member 260b′ of the image-receiving module housing 210. The photosensitive drum 230b includes an imaging surface 240′ and can be coupled with the image-receiving rollers 250 in any manner such that the imaging surface 240′ is positioned substantially opposite the image-receiving module housing 210 as shown in FIGS. 1A-B.

Being provided in the manner described in more detail above with reference to FIGS. 4A-C, the spacing device 400 comprises one or more spacing members, such as a third spacing member 400c and a fourth spacing member 400d as shown in FIGS. 9A-B. The third spacing member 400c and the fourth spacing member 400d each can be formed in any manner, including the manner described in more detail above with respect to FIGS. 4A-C. Being formed from a spacing member material, the third spacing member 400c and the fourth spacing member 400d respectively have preselected lengths Lc, Ld and preselected cross-sectional profiles Wc, Wd, each of which can be of any suitable dimension, and include proximal end regions 410a and an oppositely disposed distal end regions 410b in the manner described in more detail above. Preferably comprising substantially the same shape, dimension, and spacing member material, the third spacing member 400c and the fourth spacing member 400d can be provided with different shapes, dimensions, and/or spacing member materials, as desired. Preferably being substantially fixedly coupled with the developer cartridge 300, the spacing device 400 can be configured to be coupled with the developer cartridge 300 in any manner. For example, the proximal end regions 410a of the spacing members 400c, 400d, can be coupled with the developer cartridge 300 such that the distal end regions 410b of the spacing members 400c, 400d extend from the developer cartridge 300 at any preselected angle as described in more detail above.

When the image-receiving module 200 and the developer cartridge 300 are properly installed as shown in FIG. 9C, a predetermined development gap G is formed between the imaging surface 240′ and the developer roller periphery 340 as was described in more detail above with reference to FIG. 4C. The development gap G can comprise any predetermined distance and preferably is substantially within one or more of the ranges as defined above with respect to the development gap G (shown in FIG. 1C). In the manner described in more detail above with respect to the spacing members 400c, 400d, the spacing members 400c, 400d are configured to substantially maintain the development gap G. For example, the distal end regions 410b of the spacing members 400c, 400d are respectively configured to engage an engaging surface 220a′, 220b′ of the housing members 260a′, 260b′. Preferably substantially fixedly engaging the housing members 260a′, 260b′, the spacing members 400c, 400d can respectively engage the engaging surfaces 220a′, 220b′ in any manner as described in more detail above with reference to FIG. 4C. The preselected lengths Lc, Ld of the spacing members 400c, 400d each can be determined in any manner, including the manner described in more detail above with respect to the preselected lengths Lc, Ld of the spacing members 400c, 400d. Also in the manner described in more detail above with respect to the spacing members 400c, 400d (as shown in FIGS. 4A-C), the cross-sectional profiles Wc, Wd of the spacing members 400c, 400d can be respectively greater than, less than, or substantially equal to predetermined cross-sectional profiles Xa′, Xb′ of the respective housing members 260a′, 260b′ and/or predetermined cross-sectional profiles Ya, Yb of the respective housing members 360a, 360b.

In the manner described in more detail above with regard to FIGS. 4A-C, the spacing members 400c, 400d therefore are configured to maintain the development gap G between the imaging surface 240′ and the developer roller periphery 340 and preferably remains substantially stationary during operation of the image processing system 100. Through use of the spacing device 400, the development gap G remains substantially constant and approximately uniform along the drum width W′ of the photosensitive belt 230a and a roller length L of the developer roller 330 without damage to the image-receiving module 200 and/or the developer cartridge 300. Thereby, the image processing system 100 can efficiently develop, and consistently maintains high image quality for, electrostatic images.

While the invention is susceptible to various modifications and alternative forms, specific examples thereof have been shown by way of example in the drawings and are herein described in detail. It should be understood, however, that the invention is not to be limited to the particular forms or methods disclosed, but to the contrary, the invention is to cover all modifications, equivalents, and alternatives falling within the spirit and scope of the appended claims.

What is claimed is:

1. A spacing device for image processing systems, comprising:
a first end region being configured to engage an image-receiving module housing of an image-receiving module;
a second end region being configured to engage a developer cartridge housing of a developer cartridge; and
a preselected length being configured to substantially maintain a development gap formed substantially between an image-receiving member of said image-receiving module and a developer roller of said developer cartridge.

2. An image processing system, comprising:
an image-receiving module having an image-receiving module housing and an image-receiving member being rotatably coupled with said image-receiving module housing;
a developer cartridge having a developer cartridge housing and a developer roller being rotatably coupled with the developer cartridge housing; and
a spacing device being disposed substantially between said image-receiving module housing and said developer cartridge housing and being configured to maintain a development gap formed substantially between said image-receiving member and said developer roller.

3. A method for maintaining a development gap, comprising:
providing an image-receiving member;
disposing a developer roller at a predetermined distance from said image-receiving member to form said development gap; and
maintaining a preselected length between an image-receiving module housing rotatably coupled with said image-receiving member and a developer cartridge housing rotatably coupled with said developer roller.
